(19) United States
(12) Patent Application Publication
(10) Pub. No.: US 2023/0160502 A1
(43) Pub. Date: May 25, 2023

(54) HOSE, HOSE ARRANGEMENT AND CORRESPONDING PROCESS FOR MANUFACTURING A HOSE ARRANGEMENT

(71) Applicant: Neoperl GmbH, Müllheim (DE)

(72) Inventors: Jürgen HÖPPNER, Müllheim (DE); Daniel OECHSLE, Müllheim (DE); Holger REINHARDT, March/Buchheim (DE)

(73) Assignee: Neoperl GmbH, Müllheim (DE)

(21) Appl. No.: 17/923,092

(22) PCT Filed: May 5, 2021
(86) PCT No.: PCT/EP2021/061845

§ 371 Date: Nov. 3, 2022

(30) Foreign Application Priority Data
May 5, 2020 (DE) 20 2020 102 527.9

(51) Int. Cl. F16L 11/08; F16L 21/00

(52) U.S. Cl. CPC F16L 11/085; F16L 21/002

(57) ABSTRACT

A hose (1) having an inner hose (2) from an uncured, thermoplastic material is produced and the inner hose (2) is thermally expanded.

### TECHNICAL FIELD

The invention relates to a hose having an inner hose and a braid. The invention also relates to a hose arrangement having a hose nipple and a hose, wherein the hose nipple is arranged in a plug-in region of the hose. The invention lastly relates to a method for producing a hose arrangement, wherein a hose nipple is plugged into a hose.

### BACKGROUND

US 2007/0209728 A1 discloses a low-pressure hose for connection to diving cylinders.

DE 20 2012 100 489 U1 discloses a hose line for transporting liquid or gaseous media, having a hose layer of uncrosslinked polyethylene, wherein the hose layer has a degree of crosslinking of permanently less than 60% on account of a missing crosslinking step.

CN 205383359 U describes a flexible tube with an inner tube.

The utility model DE 20 2019 103 378 U1 discloses a flexible tube for heating systems that comprises a multiplicity of radial layers.

EP 2 048 422 A1 discloses a braided hose with a metallic visual appearance.

DE 43 20 281 A1 discloses a thermoplastic elastomer hose.

EP 1 956 149 describes a hose that is in particular in the form of a shower hose and is encapsulated by injection molding.

U.S. Pat. No. 5,124,878 describes a lightweight hose arrangement for transporting fuels and other corrosive liquids.

DE 25 57 996 A1 describes a detachable attachment connection for hydraulic and/or pneumatic lines.

CN 105402502 B discloses a method for producing a heat-insulating heating/cooling pipe made from plastic.

A method for producing a seal in an endpiece of a flexible line with a pressure shell is described in FR 3 035 171 A1.

Hoses, in particular connection hoses, having a braid are known. In this respect, the braid serves to avoid rupture of a flexible inner hose, to ensure the required tensile strength and/or to protect the inner hose against damage.

### SUMMARY

The invention is based on the object of providing a hose having improved manufacturing and/or use properties.

To achieve the object, one or more features according to the invention are provided. In particular, to achieve the stated object according to the invention in the case of a hose of the type described in the introduction, it is therefore proposed that the inner hose consists of an uncrosslinked, thermoplastic material, wherein the inner hose (2) is manufactured from PE-RT having a melt flow index (190° C./2.16 kg) of 0.5 to 2 g/10 min and a density of 0.925 to 0.960 g/cm³. It has been found that this material selection makes it possible to achieve especially favorable use properties in terms of flexibility and buckling resistance.

In this respect, it may be provided that the material PE-RT can be characterized as polyethylene (PE) having raised temperature resistance (RT), for example as type I or type II in accordance with DIN EN ISO 22391-2:2010-04, section 4.

The melt flow index may be defined, for example, in accordance with ASTM D1238 or ISO 1133.

Particularly favorable use properties can be achieved when, in a preferred configuration, the inner hose is manufactured with a density of 0.929 to 0.940 g/cm³.

To achieve the stated object, as an alternative or in addition the features of the additional independent claim directed to a hose are provided. In particular, in the case of a hose of the type described in the introduction, according to the invention it is therefore proposed that an outer diameter D of the inner hose, given and measured in mm, and a wall thickness s of the inner hose, given and measured in mm, satisfy the following:

A≤10000*s/D^{1.5}

and

10000*s/D^{1.5}≤B,

wherein A>=390 1/mm^{0.5}, preferably A=425 1/mm^{0.5}, and B<=585 1/mm^{0.5}, preferably B=565 1/mm^{0.5}. This parameter selection is particularly advantageous for achieving good buckling resistance.

In an advantageous configuration, it may be provided that the outer diameter D of the inner hose (2)<10 mm, preferably <9 mm or <7 mm. In conjunction with the braid, it is therefore possible to realize hoses that are particularly strong under tension and flexible in commercially available implementations.

In an advantageous configuration, it may be provided that the braid makes contact with the inner hose along its entire circumference and/or over a length of the braid. It is therefore possible to increase buckling resistance, in particular for the abovementioned ranges of outer diameter D and wall thickness s. The invention has recognized that a narrow braid prevents a cross section of the inner hose from becoming excessively oval when it bends, which would promote buckling.

In an advantageous configuration, it may be provided that the braid has a braid angle between 41° and 55°. This results in a good balance between tensile strength and rupture pressure resistance.

The braid angle may for example be characterized by an angle between the monofilament and a longitudinal direction (for example hose axis) in an (imaginary) unwound braid.

In general, the following variables refer to the following:

| | |
|---|---|
| Core [mm] | the outer diameter of the inliner |
| Dwire [mm] | the diameter of a single filament |
| # Wires | the number of filaments per strand |
| Pitch [mm] | the length of lay or the axial length of one complete |
| | winding of a filament around the inliner of the hose |
| # Bobbins | the number of bobbins of the braiding machine for |
| | receiving a respective braid reel, on which a strand |
| | of individual filaments was wound. |

The braid angle (“BraidAngle”) is then calculated as follows:

$$BraidAngle = arctan \frac{π * ( C o r e + 2 * Dwire )}{Pitch}$$

As an alternative or in addition, it may be provided that the braid has a coverage between 75% and 99%. This results in a good balance between buckling resistance and flexibility.

The coverage may for example be characterized by the ratio of a surface area of a surface covered by monofilaments to an overall surface containing the monofilaments and the interspaces between them in an (imaginary) unwound braid.

The coverage (“Coverage”), with the definitions above, is calculated as follows:

$$Coverage = 2 * B factor - B {factor}^{2} with B factor = \frac{Dwire * \# Wires * \# Bobbins}{2 * Pitch * sin ( BraidAngle )}$$

A braid angle between 43° and 49° and/or a coverage between 84% and 93% is/are particularly preferred. It has been found that, for this range of values, the use properties in terms of tensile strength and rupture pressure resistance and/or in terms of buckling resistance and flexibility can be particularly good.

In an advantageous configuration, it may be provided that the braid is made from a plastic monofilament having a diameter of 0.14 mm to 0.50 mm. This makes it possible to obtain braids that ensure good flexibility combined with resistance to tensile stress (along a longitudinal axis) or to loading from internal pressure or rupture.

The diameter is preferably in the range of 0.20 mm to 0.3 mm. Particularly good use properties result at a diameter of 0.25 mm±0.025 mm.

In particular, it may be provided that the plastic monofilament is manufactured from polyamide or polyester. This provides inexpensive materials with good processing properties.

In an advantageous configuration, it may be provided that the braid is made with a stainless steel monofilament having a diameter of 0.14 mm to 0.50 mm. The invention thus also makes it possible to form a hose with a metallic braid. At the values given, good use properties can be achieved.

The diameter is preferably in the range of 0.16 mm to 0.2 mm. Particularly good use properties result at a diameter of 0.18 mm±0.01 mm.

An advantageous configuration provides a hose arrangement having a hose nipple and a hose with an inner hose, as described above or claimed below, wherein the hose nipple is arranged in a plug-in region of the hose, in particular of the inner hose, and wherein an outer diameter of the hose nipple in the plug-in region is at least as great as the sum of the clear inner diameter of the hose (for example an inner hose of the hose), measured outside the plug-in region, and a wall thickness of a wall delimiting the clear inner diameter. Given an increased wall thickness of the inner hose, a sufficiently great inner diameter of the hose nipple can therefore be obtained without adversely affecting the stability of the hose nipple under mechanical loading—for example during the crimping operation.

The outer diameter of the hose nipple in the plug-in region is preferably at least as great as the sum of the clear inner diameter of the hose (for example an inner hose of the hose), measured outside the plug-in region, and 1.0, 1.1, 1.2, 1.3 or 1.4 times the wall thickness of the wall. In this instance, the result is a particularly favorable inner diameter of the hose nipple combined with sufficient mechanical stability of the hose nipple.

In an advantageous configuration, it may be provided that the hose has an inner hose and the wall has an inner hose wall. It is therefore possible for the hose nipple, when it is plugged in, to define a widening of the inner hose that does not excessively delimit the inner diameter of the hose nipple—for example in the form of a considerable obstacle to flow. The inner hose may be encompassed by a braid, for example in order to form a hose as has already been described.

To achieve the stated object, as an alternative or in addition the features of the first additional independent claim directed to a hose arrangement are provided. In particular, in the case of a hose arrangement of the type described in the introduction, it is therefore proposed that an outer diameter of the hose nipple in the plug-in region is at least as great as the sum of a clear inner diameter of the hose (for example an inner hose of the hose), measured outside of the plug-in region, and a wall thickness of a wall delimiting the clear inner diameter. Given an increased wall thickness of the inner hose, it is therefore possible to obtain a sufficiently great inner diameter of the hose nipple, without adversely affecting the stability of the hose nipple under mechanical loading—for example during the crimping operation.

The outer diameter of the hose nipple in the plug-in region is preferably at least as great as the sum of the clear inner diameter of the hose (for example an inner hose of the hose), measured outside of the plug-in region, and 1.0, 1.1, 1.2, 1.3 or 1.4 times the wall thickness of the wall. In this instance, the result is a particularly favorable inner diameter of the hose nipple combined with sufficient mechanical stability of the hose nipple.

It is particularly favorable here when, in this respect, the hose is configured according to the invention, in particular as described above and/or as claimed in one of the claims directed to the hose. The advantages of the material selection of the inner hose can therefore also be utilized in this case.

In the case of a hose arrangement, it is also provided according to the invention that the hose nipple, at its plug-in end, has an end face oriented in the plug-in direction, wherein the end face has an outer diameter d2, which is the same or greater than a clear inner diameter di of the hose outside of the plug-in region. In this respect, an outer diameter may be considered to be the same as an inner diameter, for example, when the tolerance ranges from the manufacture at least partially or even completely overlap. If the inner diameter is the same size as the outer diameter, there is no otherwise usual joining gap of approximately 4/10 mm, for example, with the result that although the end face can just be inserted into the hose, this cannot be done in a mechanical method.

It is particularly favorable here if an extension is formed at a free end of the hose nipple, which extension maintains the outer diameter beyond an axial region. An insertion aid can thus be formed.

Experience has shown that only from a joining gap of more than 4/10 mm between the inner hose and the hose nipple is it possible to perform a plugging in operation in industrial mass production in a manner which is reliable in terms of the process. The use of a joining gap has the result that an inner diameter of the hose nipple is smaller than technically necessary, as a result of which the flow resistance of the hose nipple is needlessly high. As an alternative or in addition, the use of a joining gap has the result that an outside diameter of the (inner) hose is greater than technically necessary, as a result of which the buckling stability is needlessly low. It has been shown that the matching of di and d2, which allows a joining gap of less than 4/10 mm with the (overlapping) tolerance ranges or which forms an excess length, results in advantageous properties.

In this respect, the end face may define a planar surface or have a (convexly) curved contour in an axial portion. The curved contour may be useful during the plug-in operation, while the planar surface establishes a defined termination.

In this respect, the end face may be defined, for example, as an axial projection of an outer surface of the hose nipple as far as the first holding rib in a radial plane with respect to a plug-in direction of the hose nipple. In this respect, for example, the radial plane may be characterized as the plane which is perpendicular to a longitudinal direction (for example a hose axis).

To achieve the stated object, as an alternative or in addition the features of the second additional independent claim directed to a hose arrangement are provided. In particular, in the case of a hose arrangement of the type described in the introduction, it is therefore proposed that the hose, at its plug-in end, is widened by a thermal treatment, in particular using a mandrel heated to at least a Vicat softening temperature. The Vicat softening temperature may be defined for example as VST/A/50 in accordance with DIN EN ISO 306.

The heating is preferably performed to a temperature at least 30 K or 50 K above the Vicat softening temperature. This makes it possible to have the effect that the material of the inner hose is also brought close to or above the Vicat softening temperature on the mandrel. It is therefore easy to create plastic deformation during the plugging-in or pressing-in operation.

In particular, it may be provided that the hose is designed according to the invention, in particular as described above and/or as claimed in one of the claims directed to a hose. This makes it possible to also utilize the advantages of the material selection or of the braid in this instance.

To achieve the stated object, as an alternative or in addition the features of the additional independent claim directed to a method are provided according to the invention. In particular, in the case of a method of the type described in the introduction, it is therefore proposed according to the invention that, before and/or during the plugging in of the hose nipple, an inner diameter of the hose is widened by a thermal treatment, in particular using a mandrel heated to at least a Vicat softening temperature, preferably to a temperature at least 30 K or 50 K above the Vicat softening temperature (for example VST/A/50). A method for producing a hose arrangement is thus described. The heating of the hose can result in the elimination of crack formation in the inner hose.

In an advantageous configuration, it may be provided that the mandrel is pushed into a push-in region of the hose, wherein the hose is held on the outside in the push-in region.

As an alternative, it may be provided that the hose is held partially or completely outside the push-in region. This makes it possible to be able to achieve a particularly favorable widening for plugging in the hose nipple.

In an advantageous configuration, it may be provided that a crimping sleeve is plugged on before the widening operation. This makes it possible to be able to avoid undesired splaying of the braid during assembly.

A preferred use of the hose and the hose arrangement is the sanitary hose, for example in the form of a connection hose.

It is therefore possible to realize a series of hose arrangements comprising at least two variants, each of which is a hose arrangement according to the invention, in particular as described above and/or as claimed in one of the claims directed to a hose arrangement, and/or is produced by a method according to the invention, in particular as described above and/or as claimed in one of the claims directed to a method. In particular, this makes it possible to have the effect that all variants are in the range defined by the formulae and therefore achieve a good compromise between buckling resistance and flexibility, in particular wherein the buckling resistance is improved by the braid.

In this respect it may be provided that the inner hoses of the variants have differing outer diameters D. It is thus possible to be able to design series which have variants with different throughflow classes and/or different space requirements.

As an alternative or in addition, it may be provided that the inner hoses of the variants have outer diameters D of less than 10 mm, less than 9 mm or less than 7 mm. It is thus possible to be able to design series which have variants that can be used particularly well in the kitchen sector and/or in the shower sector.

### BRIEF DESCRIPTION OF THE DRAWINGS

The invention will now be described in more detail with reference to exemplary embodiments, but is not limited to these exemplary embodiments. Further exemplary embodiments will become apparent by a combination of the features of one or more claims and/or with one or more features of the exemplary embodiments.

In the drawings:

FIG. 1 shows an axial section of a hose according to the invention in the case of a hose arrangement according to the invention,

FIG. 2 shows a method according to the invention for producing a hose arrangement,

FIG. 3 shows a further method according to the invention for producing a hose arrangement, wherein the hose is held below a push-in region for a mandrel,

FIG. 4 shows a third method according to the invention for producing a hose arrangement, wherein a crimping sleeve is placed on before the widening operation, and

FIG. 5 shows a partially axially cut-open illustration of a detail of part of a hose arrangement according to the invention (on the right-hand side) and of the associated hose nipple on its own (on the left-hand side).

### DETAILED DESCRIPTION

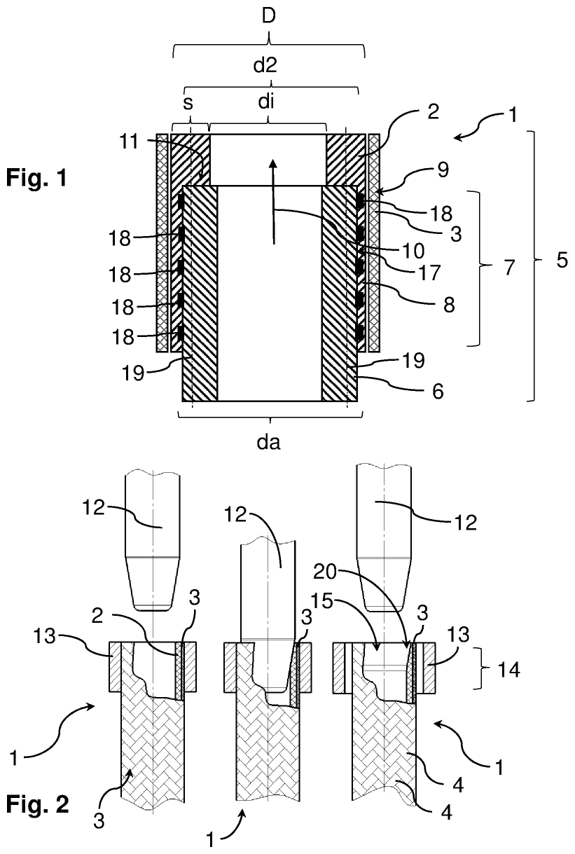

FIG. 1, in a greatly schematic form for the purpose of explaining the concept of the invention, shows a hose, denoted overall by 1, which is provided with an inner hose 2 of an uncrosslinked, thermoplastic material and a braid 3 attached to the outside of the inner hose 2.

In the exemplary embodiment, the inner hose 2 consists of PE-RT and has a melt flow index (190° C./2.16 kg) of 0.5 to 2 g/10 min and a density of 0.929 to 0.940 g/cm³. In other exemplary embodiments, the values are chosen differently, in particular a melt flow index (190° C./2.16 kg) in the range of 0.1 to 10 g/10 min and/or a density in the range of 0.925 to 0.960 g/cm³.

In the exemplary embodiment, the inner hose 2 has an outer diameter D and a wall thickness s.

The following applies for D and s in mm:

A≤10000*s/D^{1.5} and 10000*s/D^{1.5}≤B,

wherein A=425 1/mm^{0.5}, and B=565 1/mm^{0.5}. In other exemplary embodiments, the values are chosen differently, for example in the range of A>=390 1/mm^{0.5}, preferably A=425 1/mm^{0.5}, and/or B<=585 1/mm^{0.5}, preferably B=565 1/mm^{0.5}.

It is thus possible to design series of hose arrangements comprising at least two variants, each of which is designed as described above and satisfies the abovementioned relationships.

In this respect, it may be provided that in a first variant the outer diameter D is less than 10 mm, in a second variant less than 9 mm, and/or in a third variant less than 7 mm. First variant, second variant and/or third variant may also be dispensed with, with the result that only two of the three variants remain.

In the exemplary embodiment shown, the braid 3 has a braid angle between 43° and 49° and a coverage between 84% and 93%. In other exemplary embodiments, the values are chosen differently, for example a braid angle between 41° and 55° and/or a coverage between 75% and 99%.

In a first variant, the braid 3 is made with a monofilament 4 (cf. FIG. 2) of plastic, for example of polyamide or polyester. The diameter of the monofilament 4 is 0.25 mm±0.025 mm. In other exemplary embodiments, the monofilament has a different diameter, for example in the range of 0.14 mm to 0.50 mm, in particular of 0.20 mm to 0.3 mm.

In a second variant, the braid 3 is made with a stainless steel monofilament having a diameter of 0.18 mm±0.01 mm. In other exemplary embodiments, the monofilament has a different diameter, for example in the range of 0.14 mm to 0.50 mm, in particular of 0.16 mm to 0.2 mm.

To form a hose arrangement 5 according to the invention, in the exemplary embodiment shown a hose nipple 6 is plugged into the hose 1, in this instance for example the inner hose 2, and arranged in a plug-in region 7.

An outer diameter da of the hose nipple 6 in the plug-in region 7 is at least as great as the sum of a clear inner diameter di of the hose 1 (here the inner hose 2), measured outside of the plug-in region 7, and a wall thickness s of a wall 8 delimiting the clear inner diameter di, here the wall of the inner hose 2 in the form of an inner hose wall. The hose nipple 6 thus projects on each side over half of the wall thickness s, that is to say over the center line 19 of the material of the wall 8, into the undeformed inner hose 2 (that is to say outside of the plug-in region 7).

The hose nipple 6 at its plug-in end 9 has an end face 11 oriented in the plug-in direction 10. In this respect, the end face 11 may be defined for example as an axial projection of an outer surface 17 of the hose nipple 6 as far as a first holding rib 18 in a radial plane with respect to a plug-in direction of the hose nipple, or as the planar, axially facing surface. If the hose nipple (in a further exemplary embodiment) has a conical outer shape, it is therefore possible for the end face to include the first portion of the rise on the cone as far as the first holding rib, or the end face 11 only includes the axial surface at the free end 21.

The end face 11 has an outer diameter d2 which is larger than a clear inner diameter di of the hose outside of the plug-in region 7. This has the result that it is very difficult to impossible to press the hose nipple 6 into the untreated inner hose 2.

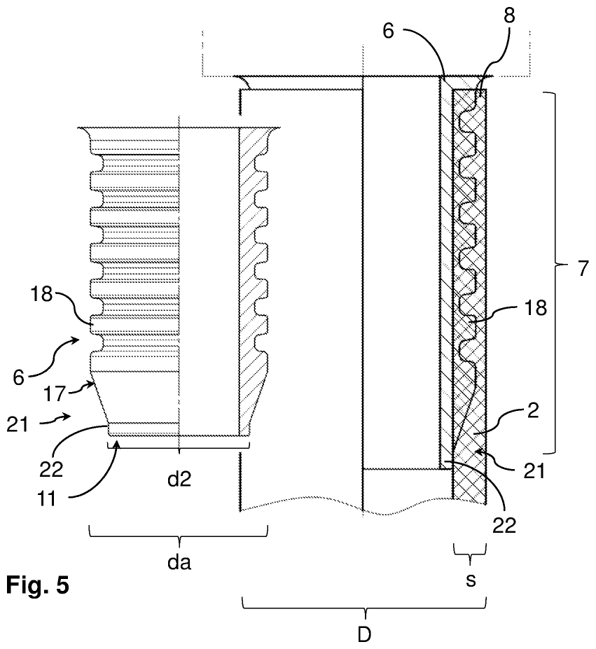

In a further exemplary embodiment according to FIG. 5, the outer diameter d2 of the end face 11 is exactly the same as the clear inner diameter di of the (inner) hose 2 outside of the plug-in region, that is to say the undeformed hose. If the overlapping tolerance ranges of the hose nipple 6 and of the inner hose 2 are taken into account, the inner diameter di will sometimes be slightly larger or slightly smaller than the outer diameter d2. This shows that it is necessary to widen the inner hose 2 before plugging in the hose nipple, even when d2<di.

While in FIG. 1 da and d2 differ only by a height of the holding ribs 18, in this instance da is significantly greater than d2, since the hose nipple 6 tapers at its free end 21 to form a (sleeve-shaped) extension 22.

In all other respects, components and functional units that have a similar or identical function and/or design in relation to FIGS. 1 to 4 are denoted by the same reference signs and are not described again separately. The embodiments relating to FIG. 1 to FIG. 4 therefore apply correspondingly.

FIG. 2 shows a production method according to the invention.

A mandrel 12 is heated (on the left-hand side) to a temperature at least 50 K above the Vicat softening temperature of the material of the inner hose 2.

The hose 1 is widened at its plug-in end 9 by a thermal treatment using the mandrel 12 (in the center).

In the process, the hose 1 is held on the outside by holding jaws 13.

In this respect, the holding jaws 13 are placed such that they enclose and support the hose 1 in a push-in region 14.

Then, the holding jaws 13 are removed again, and the mandrel 12 is pulled out (on the right-hand side).

A plastically shaped widening 15 remains, into which the hose nipple 6 can be readily pressed. The braid 3 is not widened.

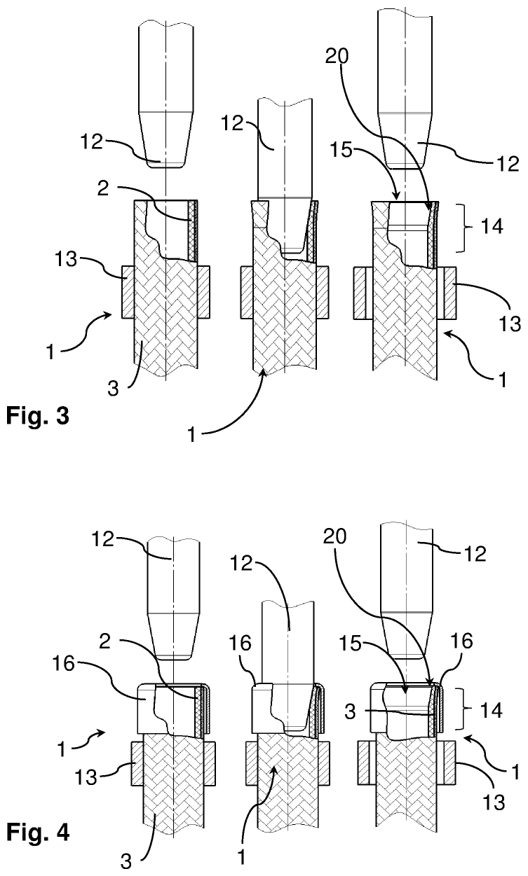

FIG. 3 shows a further method according to the invention. Components and functional units that have a similar or identical design or function in relation to the preceding exemplary embodiment are denoted by the same reference signs and are not described separately. The embodiments relating to FIGS. 1 and 2 therefore apply correspondingly here.

The exemplary embodiment according to FIG. 3 differs from that according to FIG. 2 in that the holding jaws 13 are arranged below the push-in region 14.

This has the result that the braid 3 is also widened under the influence of the mandrel 12. The inner hose 2 is thus beveled to a lesser extent in the bevel 20 than in the situation according to FIG. 2.

FIG. 4 shows a further method according to the invention. Components and functional units that have a similar or identical design or function in relation to the preceding exemplary embodiment are denoted by the same reference signs and are not described separately. The embodiments relating to FIGS. 1 to 3 therefore apply correspondingly here.

The exemplary embodiment according to FIG. 4 differs from that according to FIG. 3 in that a crimping sleeve 16 is plugged on before the widening operation. The braid 3 is therefore fixed in the plug-in end 9.

After the mandrel 12 has been pulled out (FIG. 4, on the right-hand side), the hose nipple 6 is plugged into the widening 15 and the crimping sleeve 16 is crimped.

In the case of a hose 1, it is therefore proposed according to the invention to produce an inner hose 2 from an uncrosslinked, thermoplastic material and to widen the inner hose 2 by a thermal treatment.

### LIST OF REFERENCE SIGNS

1 Hose
2 Inner hose
3 Braid
4 (Plastic/stainless steel) monofilament
5 Hose arrangement
6 Hose nipple
7 Plug-in region
8 Wall
9 Plug-in end
10 Plug-in direction
11 End face
12 Mandrel
13 Holding jaws
14 Push-in region
15 Widening
16 Crimping sleeve
17 Outer surface
18 Holding rib
19 Center line
20 Bevel
21 Free end
22 Extension
D Outer diameter D of 2
s Wall thickness of 2
da Outer diameter of 6
di Inner diameter of 2
d2 Outer diameter of 11

1. A hose (1), comprising:
an inner hose (2) and a braid (3),
the inner hose (2) comprising an uncrosslinked, thermoplastic material,
the braid (3) has a coverage between 75% and 98%,
the inner hose (2) is manufactured from PE-RT having a melt flow index (190° C./2.16 kg) of 0.5 to 2 g/10 min and a density of 0.925 to 0.960 g/cm³,
an outer diameter D of the inner hose (2), given and measured in mm, and a wall thickness s of the inner hose (2), given and measured in mm, satisfy the following:
A≤10000*s/D^{1.5}
and
10000*s/D^{1.5}≤B,
wherein A>=390 1/mm^{0.5}, and B<=585 1/mm^{0.5}.

2. The hose (1) as claimed in claim 1, wherein the inner hose (2) has a density of 0.929 to 0.940 g/cm³.

3. The hose (1) as claimed in claim 1, wherein at least one of a) the outer diameter D of the inner hose (2)<10 mm, or b) the braid makes contact with the inner hose along at least one of an entire circumference or over a length of the braid.

4. The hose (1) as claimed in claim 1, wherein the braid (3) has at least one of a) a braid angle between 41° and 55° or b) the coverage is between 84% and 93%.

5. The hose (1) as claimed in claim 1, wherein the braid (3) comprises a plastic monofilament (4) having a diameter of 0.14 mm to 0.50 mm.

6. The hose (1) as claimed in claim 1, wherein the braid is made with a stainless steel monofilament (4) having a diameter of 0.14 mm to 0.50 mm.

7. A hose arrangement (5), comprising:
a hose nipple (6);
a hose (1) having an inner hose (2) as claimed in claim 1;
the hose nipple (6) is arranged in a plug-in region (7) of the hose (1); and
an outer diameter (da) of the hose nipple (6) in the plug-in region (7) is at least as great as a sum of a clear inner diameter (di) of the hose (1) measured outside of the plug-in region (7) and a wall thickness (s) of a wall (8) delimiting the clear inner diameter (di).

8. The hose arrangement (5) as claimed in claim 8, wherein the hose (1) has an inner hose (2) and the wall (8) is an inner hose wall.

9. A hose arrangement (5), comprising:
a hose nipple (6);
a hose (1);
the hose nipple (6) is arranged in a plug-in region (7) of the hose (1);
an outer diameter (da) of the hose nipple (6) in the plug-in region (7) is at least as great as a sum of a clear inner diameter (di) of the hose (1), measured outside the plug-in region (7), and a wall thickness (s) of a wall (8) delimiting the clear inner diameter (di); and
the hose nipple (6), at a plug-in end (9) thereof, has an end face (11) which is oriented in a plug-in direction (10) and is planar or convexly curved in an axial portion, and the end face (11) has an outer diameter (d2) which is the same or greater than the clear inner diameter (di) of the hose (1) outside of the plug-in region (7).

10. The hose arrangement (5) as claimed in claim 9, wherein the hose includes an inner hose (2) and a braid (3),
the inner hose (2) comprising an uncrosslinked, thermoplastic material,
the braid (3) has a coverage between 75% and 98%,
the inner hose (2) is manufactured from PE-RT having a melt flow index (190° C./2.16 kg) of 0.5 to 2 g/10 min and a density of 0.925 to 0.960 g/cm³,
an outer diameter D of the inner hose (2), given and measured in mm, and a wall thickness s of the inner hose (2), given and measured in mm, satisfy the following:
A≤10000*s/D^{1.5}
and
10000*s/D^{1.5}≤B,
wherein A>=390 1/mm^{0.5};
the hose nipple (6) is arranged in a plug-in region (7) of the hose (1); and
the hose (1), at the plug-in end (9) thereof, is widened by a thermal treatment.

11. A method for producing a hose arrangement (5) as claimed in claim 10, the method comprising:
plugging-in the hose nipple (6) into the inner hose (2);
before and/or during the plugging in of the hose nipple (6), widening the inner diameter (di) of the hose (1) by a thermal using a mandrel (12) heated to at least a Vicat softening temperature.

12. The method as claimed in claim 11, further comprising pushing the mandrel (12) into a push-in region (14) of the hose (1), and holding an outside of the hose (1) in the push-in region (14) or partially or completely outside the push-in region (14).

13. The method as claimed in claim 11, further comprising plugging a crimping sleeve (16) on before the widening operation.

14. A series of hose arrangements, comprising at least two variants, each of which comprises the hose arrangement as claimed in claim 1, wherein the inner hoses of the variants have at least one of differing outer diameters D or outer diameters D of less than 10 mm, less than 9 mm, and less than 7 mm.

15. (canceled)
